(19) United States
(12) Patent Application Publication
(10) Pub. No.: US 2025/0291959 A1
(43) Pub. Date: Sep. 18, 2025

(54) Display with a Locally Controlled Privacy Mode

(71) Applicant: Apple Inc., Cupertino, CA (US)

(72) Inventors: Hao Chen, Campbell, CA (US); Zhenyue Luo, Campbell, CA (US); ByoungSuk Kim, Palo Alto, CA (US); Han Liu, Sunnyvale, CA (US); Jun Qi, San Jose, CA (US); Rong Liu, Cupertino, CA (US); Tao Zhan, Saratoga, CA (US); Yujia Zhai, San Jose, CA (US); Xin Huang, Fremont, CA (US); Mingxia Gu, Campbell, CA (US); Meizi Jiao, San Jose, CA (US)

(21) Appl. No.: 19/065,249

(22) Filed: Feb. 27, 2025

Related U.S. Application Data
(60) Provisional application No. 63/564,394, filed on Mar. 12, 2024.

(51) Int. Cl. G06F 21/84; G09G 3/20; G09G 3/32; G09G 5/02

(52) U.S. Cl. CPC G06F 21/84; G09G 3/2074; G09G 3/32; G09G 5/02; G09G 2320/0666; G09G 2320/0673

(57) ABSTRACT

A display may include light-emitting diode (LED) pixels. Each LED pixel may include both narrow-viewing-angle subpixels and wide-viewing-angle subpixels. Each LED pixel may include driver circuits that each drive a narrow-viewing-angle subpixel and a wide-viewing-angle subpixel of the same color. An emission logic circuit may direct a drive current from a drive circuit to one or both of a narrow-viewing-angle subpixel and a wide-viewing-angle subpixel of the same color. To correct for off-axis color shift, a pixel may include a green subpixel with two or more overlapping microlenses, a blue subpixel with two or more overlapping microlenses, and a red subpixel without any overlapping microlenses.

This application claims the benefit of U.S. provisional patent application No. 63/564,394, filed Mar. 12, 2024, which is hereby incorporated by reference herein in its entirety.

### BACKGROUND

This relates generally to electronic devices, and, more particularly, to electronic devices with displays.

Electronic devices often include displays. For example, an electronic device may have a light-emitting diode (LED) display based on light-emitting diode pixels. The display may include an active area and an inactive area.

It is within this context that the embodiments herein arise.

### SUMMARY

A display may include a substrate and a plurality of display pixels on the substrate. Each display pixel in the plurality of display pixels may include first subpixels, second subpixels having a greater viewing angle than the first subpixels, and driver circuits. Each driver circuit of the driver circuit may drive at least one of the first subpixels and at least one of the second subpixels.

A display may include a substrate and a plurality of display pixels on the substrate. Each display pixel in the plurality of display pixels may include a red subpixel that is not overlapped by any microlenses, a green subpixel that is overlapped by two or more microlenses, and a blue subpixel that is overlapped by two or more microlenses.

A display may include a substrate, a plurality of display pixels on the substrate, and an adjustable diffractive optical element layer that comprises a diffractive optical element layer interposed between first and second electrode layers. Each display pixel in the plurality of display pixels may be operable in a first mode and a second mode. The adjustable diffractive optical element layer may focus light from the display pixel in the first mode, the display pixel may have a first viewing angle in the first mode, the adjustable diffractive optical element layer may not focus light from the display pixel in the second mode, and the display pixel may have a second viewing angle that is greater than the first viewing angle in the second mode.

### BRIEF DESCRIPTION OF THE DRAWINGS

FIG. 1 is a schematic diagram of an illustrative electronic device having a display in accordance with some embodiments.

FIG. 2 is a schematic diagram of an illustrative display in accordance with some embodiments.

FIG. 3 is a diagram of an illustrative pixel circuit in accordance with some embodiments.

FIG. 4 is a top view of an illustrative display pixel with a red subpixel, a green subpixel, and a blue subpixel in accordance with some embodiments.

FIG. 5 is a side view of a display with illustrative wide-viewing-angle subpixels in accordance with some embodiments.

FIG. 6A is a side view of a display with illustrative narrow-viewing-angle subpixels that include color filter elements interposed between light-emitting diodes and microlenses in accordance with some embodiments.

FIG. 6B is a side view of a display with illustrative narrow-viewing-angle subpixels that include microlenses interposed between light-emitting diodes and color filter elements in accordance with some embodiments.

FIG. 7 is a side view of an illustrative display with a diffractive optical element layer that is used to focus light from narrow-viewing-angle subpixels in accordance with some embodiments.

FIGS. 8A and 8B are side views of an illustrative display with an adjustable diffractive optical element layer that is used to focus light from subpixels in a narrow-viewing-angle mode in accordance with some embodiments.

FIG. 9 is a top view of an illustrative pixel with a red narrow-viewing angle subpixel, a green narrow-viewing angle subpixel, a blue narrow-viewing angle subpixel, a red wide-viewing angle subpixel, a green wide-viewing angle subpixel, and a blue wide-viewing angle subpixel in accordance with some embodiments.

FIGS. 10A and 10B are circuit diagrams of illustrative driver circuits and emission logic circuits that may be used to control a narrow-viewing angle subpixel and a wide-viewing angle subpixel of the same color in accordance with some embodiments.

FIG. 11 is a top view of an illustrative display with a private region and a public region in accordance with some embodiments.

FIG. 12 is a top view of an illustrative display with multiple discrete private regions and a public region in accordance with some embodiments.

FIG. 13A is a top view of an illustrative pixel with one or more subpixels that are overlapped by two or more microlenses in accordance with some embodiments.

FIG. 13B is a side view of an illustrative subpixel that is overlapped by two or more microlenses in accordance with some embodiments.

FIG. 14A is a top view of an illustrative unit cell including private pixels and public pixels in accordance with some embodiments.

FIG. 14B is a side view of an illustrative private pixel portion of a unit cell in accordance with some embodiments.

FIGS. 14C and 14D are top views of illustrative display portions with 2×2 repeating unit cells in accordance with some embodiments.

FIG. 15 is a top view of an illustrative unit cell including private pixels with a single red private subpixel, a single green private subpixel, and a single blue private subpixel, and public pixels in accordance with some embodiments.

FIG. 16 is a top view of an illustrative display that displays private content and public content and has gamma circuitry that applies different gamma values to the public and private content in accordance with some embodiments.

### DETAILED DESCRIPTION

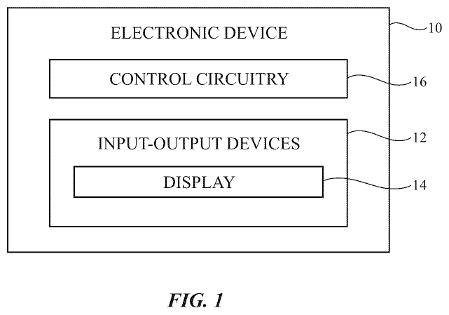

An illustrative electronic device of the type that may be provided with a display is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a display, a computer display that contains an embedded computer, a computer display that does not contain an embedded computer, a gaming device, a navigation device, an embedded system such as a system in which electronic equipment with a display is mounted in a kiosk or automobile, or other electronic equipment. Electronic device 10 may have the shape of a pair of eyeglasses (e.g., supporting frames), may form a housing having a helmet shape, or may have other configurations to help in mounting and securing the components of one or more displays on the head or near the eye of a user. As examples, electronic device 10 may be an augmented reality (AR) headset and/or virtual reality (VR) headset.

As shown in FIG. 1, electronic device 10 may include control circuitry 16 for supporting the operation of device 10. The control circuitry may include storage such as hard disk drive storage, nonvolatile memory (e.g., flash memory or other electrically-programmable-read-only memory configured to form a solid state drive), volatile memory (e.g., static or dynamic random-access memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. A touch sensor for display 14 may be formed from electrodes formed on a common display substrate with the pixels of display 14 or may be formed from a separate touch sensor panel that overlaps the pixels of display 14. If desired, display 14 may be insensitive to touch (i.e., the touch sensor may be omitted). Display 14 in electronic device 10 may be a head-up display that can be viewed without requiring users to look away from a typical viewpoint or may be a head-mounted display that is incorporated into a device that is worn on a user's head. If desired, display 14 may also be a holographic display used to display holograms.

Control circuitry 16 may be used to run software on device 10 such as operating system code and applications. During operation of device 10, the software running on control circuitry 16 may display images on display 14.

Display 14 may be an organic light-emitting diode display, a display formed from an array of discrete light-emitting diodes (microLEDs) each formed from a crystalline semiconductor die, a liquid crystal display, or any other suitable type of display. Device configurations in which display 14 includes microLEDs are sometimes described herein as an example. This is, however, merely illustrative.

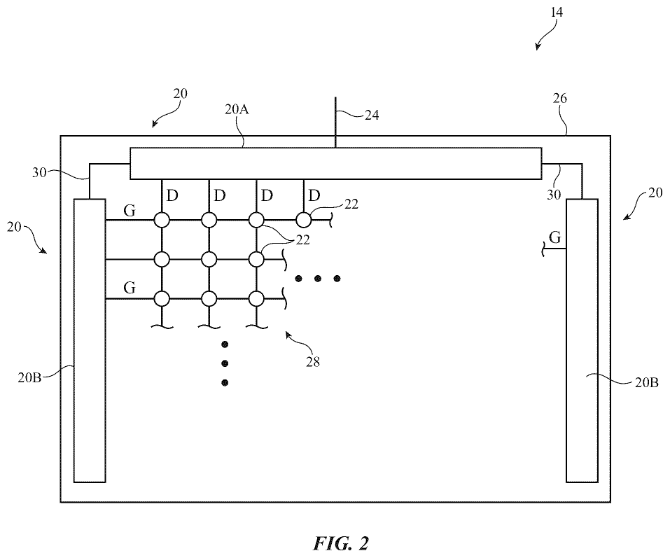

FIG. 2 is a diagram of an illustrative display. As shown in FIG. 2, display 14 may include layers such as substrate layer 26. Substrate layers such as layer 26 may be formed from rectangular planar layers of material or layers of material with other shapes (e.g., circular shapes or other shapes with one or more curved and/or straight edges). The substrate layers of display 14 may include glass layers, polymer layers, silicon layers, composite films that include polymer and inorganic materials, metallic foils, etc.

Display 14 may have an array of pixels 22 for displaying images for a user such as pixel array 28. Pixels 22 in array 28 may be arranged in rows and columns. The edges of array 28 may be straight or curved (i.e., each row of pixels 22 and/or each column of pixels 22 in array 28 may have the same length or may have a different length). There may be any suitable number of rows and columns in array 28 (e.g., ten or more, one hundred or more, or one thousand or more, etc.). Display 14 may include pixels 22 of different colors. As an example, display 14 may include red pixels, green pixels, and blue pixels.

Display driver circuitry 20 may be used to control the operation of pixels 28. Display driver circuitry 20 may be formed from integrated circuits, thin-film transistor circuits, and/or other suitable circuitry. Illustrative display driver circuitry 20 of FIG. 2 includes display driver circuitry 20A and additional display driver circuitry such as gate driver circuitry 20B. Gate driver circuitry 20B may be formed along one or more edges of display 14. For example, gate driver circuitry 20B may be arranged along the left and right sides of display 14 as shown in FIG. 2.

As shown in FIG. 2, display driver circuitry 20A (e.g., one or more display driver integrated circuits, thin-film transistor circuitry, etc.) may contain communications circuitry for communicating with system control circuitry over signal path 24. Path 24 may be formed from traces on a flexible printed circuit or other cable. The control circuitry may be located on one or more printed circuits in electronic device 10. During operation, control circuitry (e.g., control circuitry 16 of FIG. 1) may supply circuitry such as a display driver integrated circuit in circuitry 20 with image data for images to be displayed on display 14. Display driver circuitry 20A of FIG. 2 is located at the top of display 14. This is merely illustrative. Display driver circuitry 20A may be located at both the top and bottom of display 14 or in other portions of device 10.

To display the images on pixels 22, display driver circuitry 20A may supply corresponding image data to data lines D while issuing control signals to supporting display driver circuitry such as gate driver circuitry 20B over signal paths 30. With the illustrative arrangement of FIG. 2, data lines D run vertically through display 14 and are associated with respective columns of pixels 22.

Gate driver circuitry 20B (sometimes referred to as gate line driver circuitry or horizontal control signal circuitry) may be implemented using one or more integrated circuits and/or may be implemented using thin-film transistor circuitry on substrate 26. Horizontal control lines G (sometimes referred to as gate lines, scan lines, emission control lines, etc.) run horizontally through display 14. Each gate line G is associated with a respective row of pixels 22. If desired, there may be multiple horizontal control lines such as gate lines G associated with each row of pixels. Individually controlled and/or global signal paths in display 14 may also be used to distribute other signals (e.g., power supply signals, etc.).

Gate driver circuitry 20B may assert control signals on the gate lines G in display 14. For example, gate driver circuitry 20B may receive clock signals and other control signals from circuitry 20A on paths 30 and may, in response to the received signals, assert a gate line signal on gate lines G in sequence, starting with the gate line signal G in the first row of pixels 22 in array 28. As each gate line is asserted, data from data lines D may be loaded into a corresponding row of pixels. In this way, control circuitry such as display driver circuitry 20A and 20B may provide pixels 22 with signals that direct pixels 22 to display a desired image on display 14. Each pixel 22 may have a light-emitting diode and circuitry (e.g., thin-film circuitry on substrate 26) that responds to the control and data signals from display driver circuitry 20.

Gate driver circuitry 20B may include blocks of gate driver circuitry such as gate driver row blocks. Each gate driver row block may include circuitry such output buffers and other output driver circuitry, register circuits (e.g., registers that can be chained together to form a shift register), and signal lines, power lines, and other interconnects. Each gate driver row block may supply one or more gate signals to one or more respective gate lines in a corresponding row of the pixels of the array of pixels in the active area of display 14.

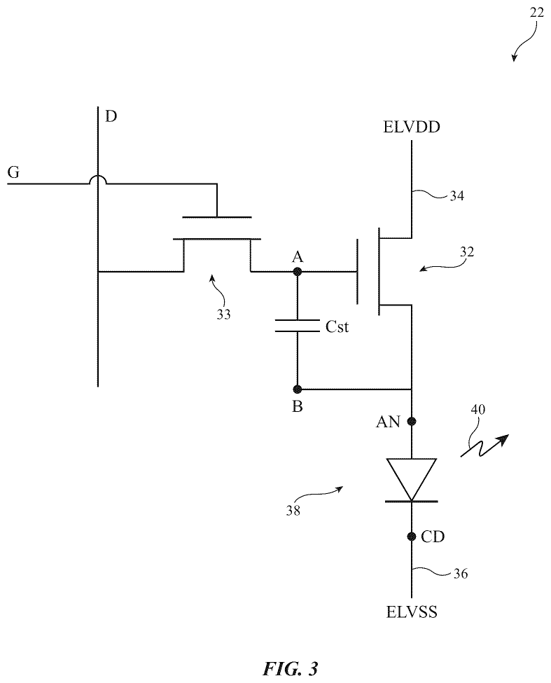

A schematic diagram of an illustrative pixel circuit of the type that may be used for each pixel 22 in array 28 is shown in FIG. 3. As shown in FIG. 3, display pixel 22 may include light-emitting diode 38. A positive power supply voltage ELVDD may be supplied to positive power supply terminal 34 and a negative (ground) power supply voltage ELVSS may be supplied to ground power supply terminal 36. Diode 38 has an anode (terminal AN) and a cathode (terminal CD). The state of drive transistor 32 controls the amount of current flowing through diode 38 and therefore the amount of emitted light 40 from display pixel 22. Cathode CD of diode 38 is coupled to ground terminal 36, so cathode terminal CD of diode 38 may sometimes be referred to as the ground terminal for diode 38.

To ensure that transistor 32 is held in a desired state between successive frames of data, display pixel 22 may include a storage capacitor such as storage capacitor Cst. The voltage on storage capacitor Cst is applied to the gate of transistor 32 at node A to control transistor 32. Data can be loaded into storage capacitor Cst using one or more switching transistors such as switching transistor 33. When switching transistor 33 is off, data line D is isolated from storage capacitor Cst and the gate voltage on terminal A is equal to the data value stored in storage capacitor Cst (i.e., the data value from the previous frame of display data being displayed on display 14). When gate line G (sometimes referred to as a scan line) in the row associated with display pixel 22 is asserted, switching transistor 33 will be turned on and a new data signal on data line D will be loaded into storage capacitor Cst. The new signal on capacitor Cst is applied to the gate of transistor 32 at node A, thereby adjusting the state of transistor 32 and adjusting the corresponding amount of light 40 that is emitted by light-emitting diode 38. If desired, the circuitry for controlling the operation of light-emitting diodes for display pixels in display 14 (e.g., transistors, capacitors, etc. in display pixel circuits such as the display pixel circuit of FIG. 3) may be formed using other configurations (e.g., configurations that include circuitry for compensating for threshold voltage variations in drive transistor 32, etc.). The display pixel circuit of FIG. 3 is merely illustrative.

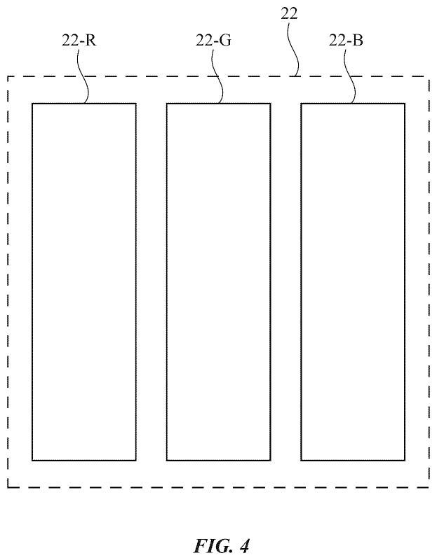

In some arrangements, each pixel 22 may include a plurality of subpixels. FIG. 4 is a top view of an illustrative pixel 22 that includes a red subpixel 22-R, a green subpixel 22-G, and a blue subpixel 22-B. Each subpixel may be connected to a respective data line and gate line and may be controlled individually. In other words, each one of the red, blue, and green subpixels in pixel 22 may have an individually controlled luminance to control the overall luminance and color of pixel 22.

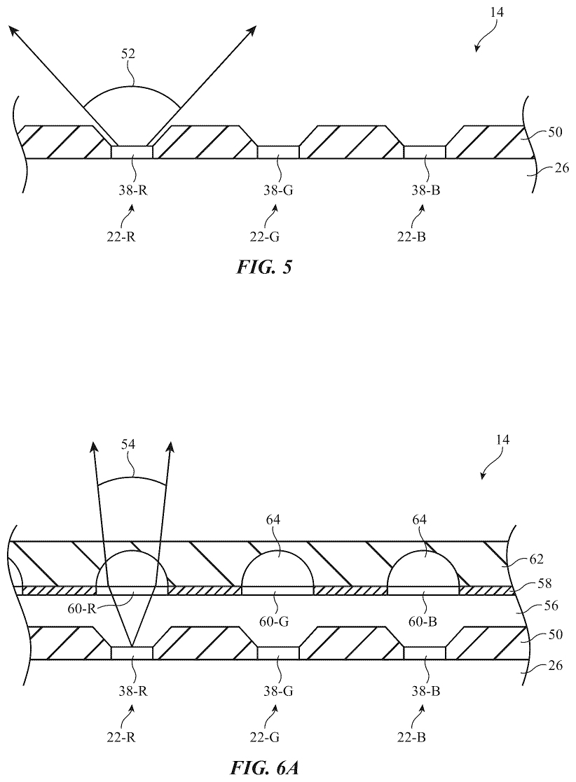

In some situations, it may be desirable to restrict the viewing angle of one or more pixels in display 14 to increase the privacy associated with those pixels. FIG. 5 is a cross-sectional side view of public subpixels that have a wide viewing angle. As shown in FIG. 5, display 14 may include, on substrate 26, a red light-emitting diode 38-R for subpixel 22-R, a green light-emitting diode 38-G for subpixel 22-G, and a blue light-emitting diode 38-B for subpixel 22-B. A pixel definition layer 50 may be interposed between the light-emitting diodes and may form apertures through which light from the light-emitting diodes is emitted.

In FIG. 5, each subpixel has an associated viewing angle 52. Viewing angle refers to the range of angles across which light from a subpixel is emitted. In FIG. 5, the subpixels' viewing angle may be relatively large and therefore the subpixels may be easily viewed by multiple viewers. These types of subpixels may therefore be referred to as wide-viewing-angle subpixels, public subpixels, unrestricted subpixels, etc.

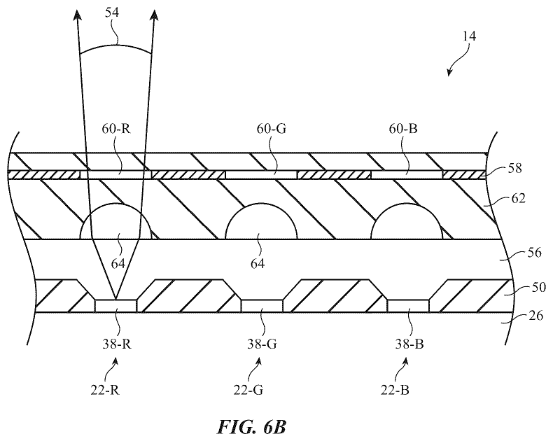

FIG. 6A is a cross-sectional side view of private subpixels that have a narrow viewing angle. As shown in FIG. 6A, display 14 may include, on substrate 26, a red light-emitting diode 38-R for subpixel 22-R, a green light-emitting diode 38-G for subpixel 22-G, and a blue light-emitting diode 38-B for subpixel 22-B. A pixel definition layer 50 may be interposed between the light-emitting diodes and may form apertures through which light from the light-emitting diodes is emitted.

To restrict the viewing angle of the subpixels, display 14 in FIG. 6A includes microlenses 64 and black matrix 58. Each one of light-emitting diodes 38 is covered by a respective microlens 64. Each one of light-emitting diodes 38 may also be covered by a respective color filter element 60. As shown in FIG. 6A, red light-emitting diode 38-R emits light through red color filter element 60-R and microlens 64. Green light-emitting diode 38-G emits light through green color filter element 60-G and microlens 64. Blue light-emitting diode 38-B emits light through blue color filter element 60-B and microlens 64. Black matrix 58 may be formed from an opaque material that transmits less than 20% of incident light, less than 10% of incident light, less than 5% of incident light, etc. Color filter elements 60 and microlenses 64 overlap openings in the black matrix.

As shown in FIG. 6A, light emitted by a subpixel passes through the color filter element for that subpixel (through an opening in black matrix 58) and is then focused by microlens 64 to have a viewing angle 54 that is smaller than viewing angle 52 in FIG. 5. Microlens 64 (in combination with a black matrix opening) therefore restricts the viewing angle of the subpixel. Including the color filter element in addition to the microlens may mitigate crosstalk within display 14.

The magnitude of viewing angle 54 may be less than 60 degrees, less than 50 degrees, less than 40 degrees, less than 30 degrees, less than 20 degrees, etc. The magnitude of viewing angle 52 may be greater than 100 degrees, greater than 120 degrees, greater than 140 degrees, etc. The difference between viewing angle 52 and viewing angle 54 may be greater than 20 degrees, greater than 40 degrees, greater than 60 degrees, greater than 80 degrees, greater than 100 degrees, greater than 120 degrees, etc.

FIG. 6A shows how display 14 may include one or more encapsulation layers 56 and one or more planarization layers 62. In the example of FIG. 6A, the one or more encapsulation layers 56 conform to pixel definition layer 50 and light-emitting diodes 38. Black matrix 58 and color filter elements 60 are formed on an upper surface of encapsulation layer(s) 56. The one or more planarization layers 62 conform to the upper surface of black matrix 58 and microlenses 64. The difference in index of refraction between microlens 64 and planarization layer(s) 62 may be greater than 0.1, greater than 0.2, greater than 0.3, greater than 0.4, greater than 0.5, etc.

In FIG. 6A, the subpixels' viewing angle may be relatively small and therefore the subpixels may not be easily viewed by multiple viewers. These types of subpixels may therefore be referred to as narrow-viewing-angle subpixels, private subpixels, restricted subpixels, etc.

The example in FIG. 6A of color filter elements 60 being interposed between microlenses 64 and light-emitting diodes 38 is merely illustrative. In another possible arrangement, shown in FIG. 6B, color filter elements 60 and black matrix 58 may be formed above microlenses 64 such that microlenses 64 are interposed between color filter elements 60 and light-emitting diodes 38.

In FIG. 6B, microlenses 64 are again formed on an upper surface of encapsulation layer(s) 56. One or more planarization layers 62 covers and conforms to the upper surface of microlenses 64 and encapsulation layer(s) 56. Black matrix layer 58 is embedded in the one or more planarization layers 62. Black matrix layer 58 has openings that each include a respective color filter element 60. As shown in FIG. 6B, red light-emitting diode 38-R emits light through red color filter element 60-R. Green light-emitting diode 38-G emits light through green color filter element 60-G. Blue light-emitting diode 38-B emits light through blue color filter element 60-B.

As shown in FIG. 6B, light emitted by a subpixel passes through the microlens 64 for that subpixel to narrow the viewing angle of the emitted light. The focused light then passes through the color filter element 60 for that subpixel. Microlens 64 (in combination with the black matrix openings) therefore restricts the viewing angle of the subpixel. In FIG. 6B, the viewing angle 54 of the emitted light is the same as in FIG. 6A. The subpixels of FIG. 6B may therefore be referred to as narrow-viewing-angle subpixels, private subpixels, restricted subpixels, etc.

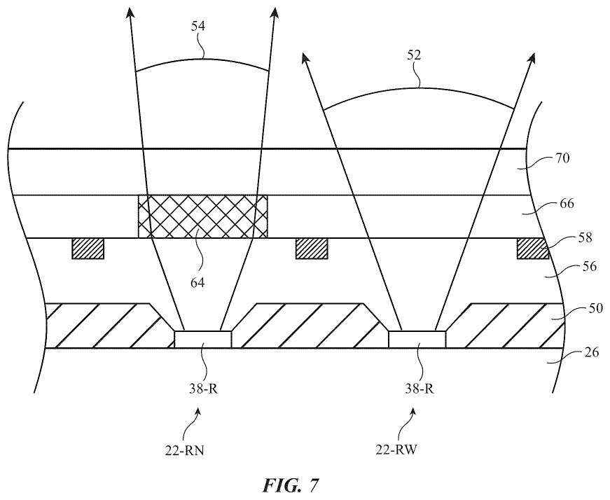

The example of using microlenses to form narrow-viewing-angle subpixels is merely illustrative. In another possible arrangement, shown in FIG. 7, narrow-viewing-angle subpixels are formed using a diffractive optical element (DOE) such as a holographic optical element (HOE). In the example of FIG. 7, narrow-viewing-angle subpixel 22-RN includes a red light-emitting diode 38-R and wide-viewing-angle subpixel 22-RW includes a red light-emitting diode 38-R. Pixel definition layer 50 defines apertures for the light-emitting diodes. One or more encapsulation layers 56 are formed over the light-emitting diodes and pixel definition layer.

In FIG. 7, a diffractive optical element (DOE) layer 66 is formed on an upper surface of encapsulation layer(s) 56. DOE layer 66 may include one or more discrete portions 68 that include DOEs. Each DOE portion 68 may overlap a respective light-emitting diode for a narrow-viewing-angle subpixel. Each DOE portion 68 may include an HOE. As shown in FIG. 7, for the narrow-viewing-angle subpixels, light emitted by the light-emitting diode is focused by DOE portion 68 and exits with a relatively narrow viewing angle 54. In contrast, since there are no DOE portions that overlap the wide-viewing-angle subpixels, the light from the wide-viewing-angle subpixels passes through DOE layer 66 without substantial redirection and exits with a relatively wide viewing angle 52.

As shown in FIG. 7, black matrix layer 58 may have portions between adjacent subpixels to mitigate crosstalk. The display may also include a display cover layer 70 that overlaps DOE layer 66. Display cover layer 70 may be formed from a transparent material such as glass, plastic, sapphire, etc.

FIG. 7 shows a static DOE layer 66 where the positions of DOE portions 68 are fixed. In other words, light from subpixel 22-RN will be focused by DOE portion 68 whenever subpixel 22-RN emits light and light from subpixel 22-RW will not be focused by a DOE portion whenever subpixel 22-RW emits light. As shown in FIG. 7, display 14 may include both narrow-viewing-angle subpixels and wide-viewing-angle subpixels. This example is merely illustrative. In another possible arrangement, DOE layer 66 may be an adjustable DOE layer. In the adjustable DOE layer, portions of the DOE layer may selectively be switched between a privacy mode (sometimes referred to as a narrow-viewing angle mode, restricted mode, focusing mode, etc.) in which light is focused by a DOE portion 68 and a public mode (sometimes referred to as a wide-viewing angle mode, unrestricted mode, normal mode, etc.) in which light is not focused by a DOE portion.

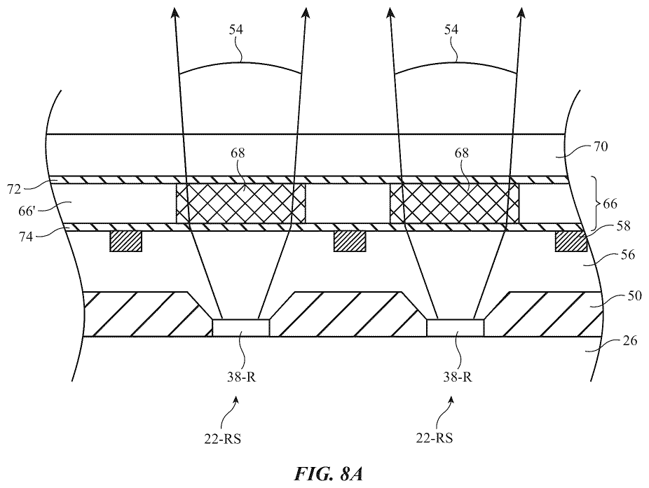

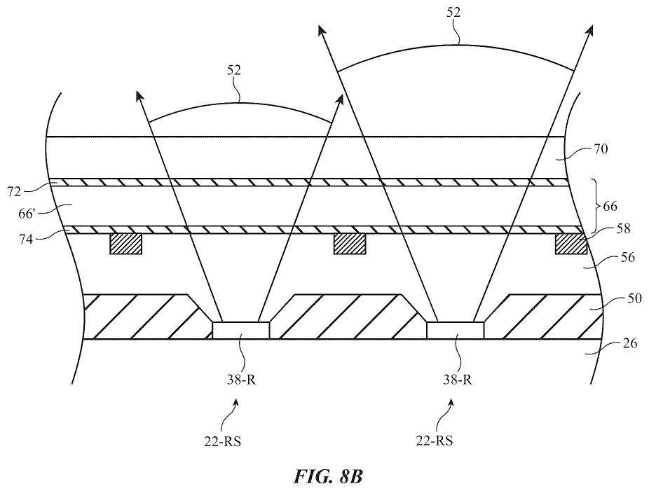

FIGS. 8A and 8B show a display with an adjustable DOE layer. FIG. 8A shows the adjustable DOE layer in a private mode (e.g., for narrow viewing angles) and FIG. 8B shows the adjustable DOE layer in a public mode (e.g., for wide viewing angles). As shown in FIG. 8A, display 14 may include red switchable-viewing-angle subpixels 22-RS that include red light-emitting diodes 38-R. Pixel definition layer 50 defines apertures for the light-emitting diodes. One or more encapsulation layers 56 are formed over the light-emitting diodes and pixel definition layer. Black matrix layer 58 may have portions between adjacent subpixels to mitigate crosstalk. The display may also include a display cover layer 70 that overlaps adjustable DOE layer 66. Display cover layer 70 may be formed from a transparent material such as glass, plastic, sapphire, etc.

In FIGS. 8A and 8B, an adjustable diffractive optical element (DOE) layer 66 is formed on an upper surface of encapsulation layer(s) 56. Adjustable DOE layer 66 may include a DOE layer 66′ that is interposed between first and second electrodes 72 and 74. Electrodes 72 and 74 may be formed from a transparent conductive material such as indium tin oxide. The voltage across electrodes 72 and 74 may be adjusted to selectively adjust DOE layer 66′.

For each pixel, DOE layer 66′ may have a first state and a second state. In the first state, show in FIG. 8A, DOE portions 68 are present for each switchable-viewing-angle subpixel and the switchable-viewing-angle subpixels are in a narrow-viewing-angle mode where light is focused by DOE portions 68 to exit the display with a relatively narrow viewing angle 54. In the second state, shown in FIG. 8B, there are no DOE portions present in DOE layer 66′ and the switchable-viewing-angle subpixels are in a wide-viewing-angle mode where light is not focused by DOE layer 66′ and exits the display with a relatively wide viewing angle 52.

Electrode layers 72 and 74 may be patterned for individual control of the mode of each subpixel in display 14. Electrode layers 72 and 74 may optionally be patterned so that groups of two or more subpixels are controlled in unison.

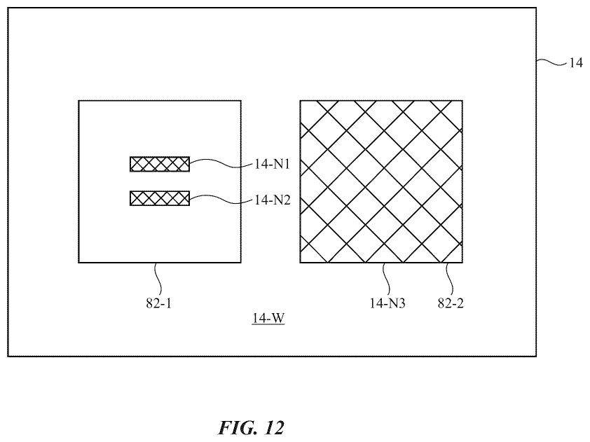

A display may optionally have an arrangement where every subpixel is a switchable-viewing-angle subpixel of the type shown in FIG. 8. In this way, the DOE layer may be controlled to selectively place each switchable-viewing-angle subpixel in a wide-viewing-angle mode or a narrow-viewing-angle mode. Subpixels in a region on display 14 where privacy is desired may therefore all be placed in the narrow-viewing-angle mode. There may be multiple discrete privacy regions on the display if desired (e.g., as shown subsequently in FIG. 12).

FIGS. 5 and 7 show examples of subpixels with fixed wide viewing angles. FIGS. 6A, 6B, and 7 show examples of subpixels with fixed narrow viewing angles. In some displays, all of the subpixels may be subpixels with fixed narrow viewing angles. In this type of display, all of the display may have a narrow viewing angle that is suitable for private content. In some displays, all of the subpixels may be subpixels with fixed wide viewing angles. In this type of display, all of the display may have a wide viewing angle that is suitable for public content.

In another possible arrangement, some of the subpixels may be subpixels with fixed narrow viewing angles and other subpixels may be subpixels with fixed wide viewing angles. As one example, there may be one or more discrete regions of the display with narrow-viewing-angle subpixels suitable for private content and one or more discrete regions of the display with wide-viewing-angle subpixels suitable for public content. During operation of electronic device 10, private content may be placed in the one or more discrete regions of the display with narrow-viewing-angle subpixels.

In yet another possible arrangement, display 14 may include an array of pixels where each pixel includes some narrow-viewing-angle subpixels and some wide-viewing-angle subpixels. When it is desirable to place the pixel in a private mode, only the narrow-viewing-angle subpixels may be used to emit light. When it is desirable to place the pixel in a public mode, the wide-viewing-angle subpixels may be used to emit light instead of or in addition to the narrow-viewing-angle subpixels.

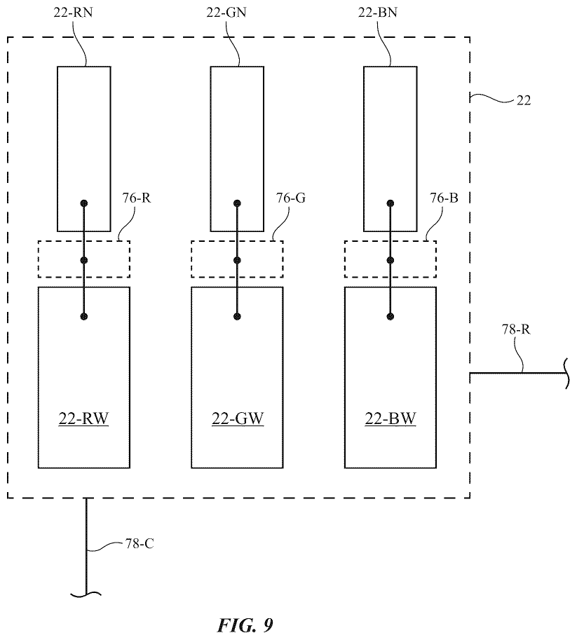

FIG. 9 is a top view of an illustrative pixel with both narrow-viewing-angle subpixels and wide-viewing-angle subpixels. As shown in FIG. 9, pixel 22 includes a red narrow-viewing-angle subpixel 22-RN, a red wide-viewing-angle subpixel 22-RW, a green narrow-viewing-angle subpixel 22-GN, a green wide-viewing-angle subpixel 22-GW, a blue narrow-viewing-angle subpixel 22-BN, and a blue wide-viewing-angle subpixel 22-BW. When it is desired for pixel 22 to operate in a private mode (sometimes referred to as a narrow-viewing-angle mode or restricted mode), subpixels 22-RN, 22-GN, and/or 22-BN emit light (while subpixels 22-RW, 22-GW, and 22-BW do not emit light). When it is desired for pixel 22 to operate in a public mode (sometimes referred to as a wide-viewing-angle mode or unrestricted mode), subpixels 22-RW, 22-GW, and/or 22-BW emit light (while subpixels 22-RN, 22-GN, and 22-BN optionally emit light).

The layout shown in FIG. 9 is merely illustrative. In general, each narrow-viewing-angle subpixel and each wide-viewing-angle subpixel may have any desired footprint in any desired relative arrangement.

In some cases, each subpixel may have a respective driver circuit (e.g., a drive transistor, one or more emission transistors, and one or more switching transistors that control the emission of light from a subpixel). Each driver circuit may receive pixel data from a respective data line D and gate signals from one or more gate lines G. Alternatively, to mitigate the cost and complexity of manufacturing display 14 as well as mitigate the space required for the driver circuits, subpixels of the same color within pixel 22 may share a driver circuit. As shown in FIG. 9, a first driver circuit 76-R may be used to drive both red narrow-viewing-angle pixel 22-RN and red wide-viewing-angle pixel 22-RW, a second driver circuit 76-G may be used to drive both green narrow-viewing-angle pixel 22-GN and green wide-viewing-angle pixel 22-GW, and a third driver circuit 76-B may be used to drive both blue narrow-viewing-angle pixel 22-BN and blue wide-viewing-angle pixel 22-BW.

In addition to the gate signals and data signals discussed in connection with FIG. 2, each driver circuit may receive one or more privacy mode selection signals such as a privacy mode row selection signal and a privacy mode column selection signal. As shown in FIG. 9, each pixel may be connected to a privacy mode row signal line 78-R that provides the same privacy mode row selection signal to a row of pixels in display 14 and a privacy mode column signal line 78-C that provides the same privacy mode column selection signal to a column of pixels in display 14.

The privacy mode row selection signal may have a first value associated with a privacy mode and a second value associated with a public mode. The privacy mode column selection signal may have a first value associated with a privacy mode and a second value associated with a public mode. When a pixel receives a privacy mode row selection signal and a privacy mode column selection signal that both have the first value, that pixel may be placed in the privacy mode and driver circuits 76 may provide drive current to only the narrow-viewing-angle subpixels. When a pixel receives a privacy mode row selection signal or a privacy mode column selection signal that has the second value, that pixel may be placed in the public mode and driver circuits 76 may provide drive current to the wide-viewing-angle subpixels to emit light (instead of or in addition to the narrow-viewing-angle subpixels).

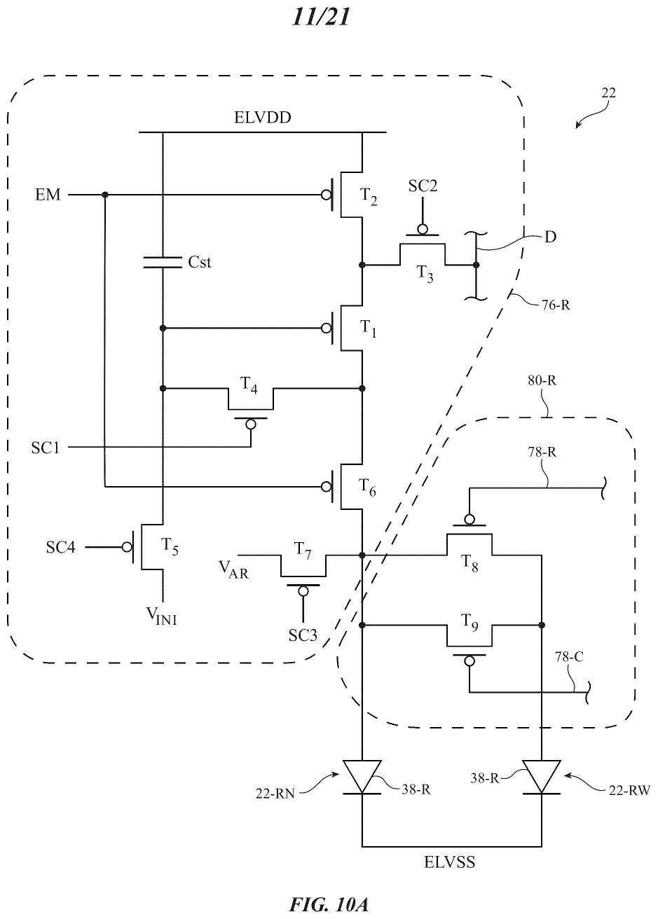

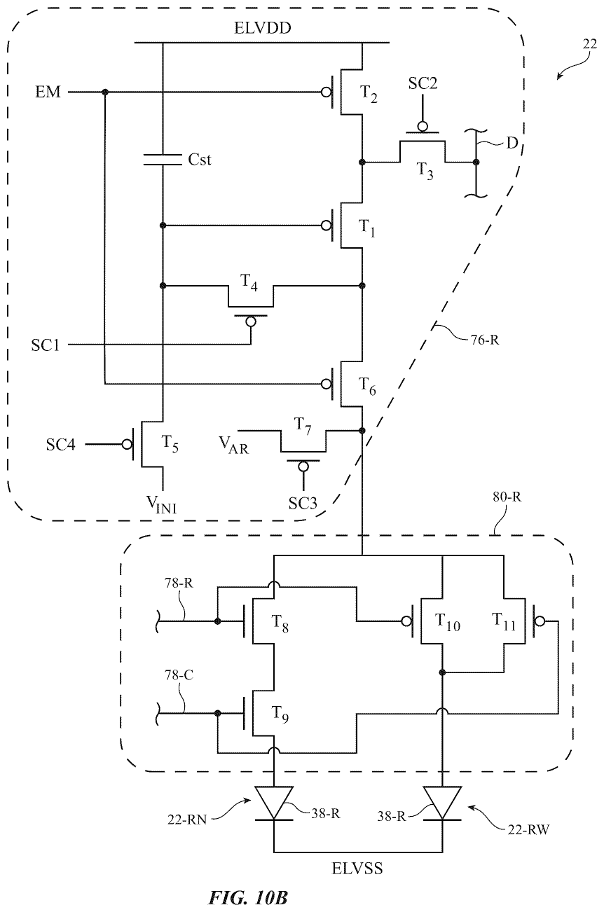

FIG. 10A is a circuit diagram for an illustrative driver circuit that drives both a narrow-viewing-angle subpixel and a wide-viewing-angle subpixel. As shown in FIG. 10A, driver circuit 76-R may include a storage capacitor Cst and transistors such as switching transistors T₄ and T₅, drive transistor T₁, a data loading transistor T₃, a first emission transistor T₂, an anode reset transistor T₇, and second emission transistor T₆. Each transistor may optionally be formed using semiconducting oxide (e.g., a transistor with a channel formed from semiconducting oxide such as indium gallium zinc oxide or IGZO) or silicon (e.g., polysilicon channel deposited using a low temperature process, sometimes referred to as LTPS or low-temperature polysilicon). Semiconducting-oxide transistors exhibit lower leakage than silicon transistors, so implementing transistors T₄ and T₅ as semiconducting-oxide transistors may help reduce flicker (e.g., by preventing current from leaking away from the gate terminal of drive transistor T₁).

As shown in FIG. 10A, display pixel 22 may include two red light-emitting diodes 38-R. The two light-emitting diodes are connected in parallel between a positive power supply voltage ELVDD (supplied at a positive power supply terminal) and a ground power supply voltage ELVSS (supplied at a ground power supply terminal). Positive power supply voltage ELVDD may be 3 V, 4 V, 5 V, 6 V, 7 V, 2 to 8 V, or any suitable positive power supply voltage level. Ground power supply voltage ELVSS may be 0 V, −1 V, −2 V, −3 V, −4 V, −5 V, −6V, −7 V, or any suitable ground or negative power supply voltage level. The state of drive transistor T₁ controls the amount of current exiting driver circuit 76-R and flowing from ELVDD to ELVSS. An emission logic circuit 80-R may direct the current from driver circuit 76-R to one or both of diodes 38-R.

T₅ may receive an initialization voltage Vini (e.g., a negative voltage such as −1 V, −2 V, −3 V, −4V, −5 V, −6 V, or other suitable voltage) to assist in turning off the diodes 38-R when the diodes 38-R are not in use. Control signals from display driver circuitry such as gate driver circuitry 20B of FIG. 2 are supplied to the transistors in driver circuit 76-R. Transistors T₂ and T₆ receive an emission control signal EM. Transistor T₄ receives a control signal SC1. Transistor T₃ receives a control signal SC2. Transistor T₇ receives a control signal SC3. Transistor T₅ receives a control signal SC4. Transistor T₃ may be connected to a data line D. Transistor T₇ may receive an anode reset voltage VAR.

The driver circuit 76-R of FIG. 10A is merely illustrative. In general, the driver circuit may have one or more additional transistors and/or one or more of transistors T₁-T₇ may optionally be removed.

Driver circuit 76-R is therefore used to drive the light-emitting diode for both subpixels 22-RN and 22-RW. In addition to driver circuit 76-R, pixel 22 may include emission logic 80-R that is associated with subpixels 22-RN and 22-RW. In particular, the emission logic 80-R may be used to control whether the driving current (with a magnitude set by driver circuit 76-R) is applied to subpixel 22-RN, subpixel 22-RW, or both.

FIG. 10A shows an example where emission logic 80-R includes two transistors. A first transistor T₈ is interposed between driver circuit 76-R (e.g., a node between T₆ and light-emitting diodes 38-R) and the light-emitting diode for subpixel 22-RW. A second transistor T₉ is interposed between driver circuit 76-R and the light-emitting diode for subpixel 22-RW. Transistor T₈ has a gate that receives a signal from privacy mode row signal line 78-R whereas transistor T₉ has a gate that receives a signal from privacy mode column signal line 78-C.

With the arrangement of FIG. 10A, current from driver circuit 76-R always passes through LED 38-R for narrow-viewing-angle subpixel 22-RN. In other words, the narrow-viewing-angle subpixel 22-RN is always on. Privacy mode row signal line 78-R and privacy mode column signal line 78-C may provide privacy mode control signals that optionally turn on the wide-viewing-angle subpixel 22-RW. If either privacy mode row signal line 78-R or privacy mode column signal line 78-C receives a control signal associated with a public mode, the corresponding transistor is asserted and wide-viewing-angle subpixel 22-RW is turned on.

Consider an example where privacy mode row signal line 78-R provides a control signal associated with a private mode and privacy mode column signal line 78-C also provides a control signal associated with a private mode. In this instance, both transistors T₈ and T₉ are deasserted and light is only emitted by subpixel 22-RN.

Consider an example where privacy mode row signal line 78-R provides a control signal associated with a private mode and privacy mode column signal line 78-C provides a control signal associated with a public mode. In this instance, transistor T₈ is deasserted but transistor T₉ is asserted. Light is therefore emitted by both subpixels 22-RN and 22-RW.

Consider an example where privacy mode row signal line 78-R provides a control signal associated with a public mode and privacy mode column signal line 78-C provides a control signal associated with a private mode. In this instance, transistor T₈ is asserted and transistor T₉ is deasserted. Light is therefore emitted by both subpixels 22-RN and 22-RW.

Consider an example where privacy mode row signal line 78-R provides a control signal associated with a public mode and privacy mode column signal line 78-C also provides a control signal associated with a public mode. In this instance, both transistors T₈ and T₉ are asserted and light is emitted by both subpixels 22-RN and 22-RW.

FIG. 10A therefore shows an example for emission logic circuit 80-R where narrow-viewing-angle subpixel 22-RN is always on and wide-viewing-angle subpixel 22-RW is selectively turned on in addition to subpixel 22-RN. In another possible arrangement, shown in FIG. 10B, narrow-viewing-angle subpixel 22-RN may be turned off when wide-viewing-angle subpixel 22-RW is turned on.

FIG. 10B shows an example where emission logic 80-R includes four transistors. Transistors T₈ and T₉ are connected in series between driver circuit 76-R and the light-emitting diode for subpixel 22-RN. Transistors T₁₀ and T₁₁ are connected in parallel between driver circuit 76-R and the light-emitting diode for subpixel 22-RW. Transistors T₈ and T₁₀ have gates that receive a signal from privacy mode row signal line 78-R whereas transistors T₉ and T₁₁ have gates that receive a signal from privacy mode column signal line 78-C. Transistors T₈ and T₁₀ may be of the opposite type (e.g., T₈ is an nMOS transistor whereas T₁₀ is a pMOS transistor). Transistors T₉ and T₁₁ may be of the opposite type (e.g., To is an nMOS transistor whereas T₁₁ is a pMOS transistor).

With the arrangement of FIG. 10B, current from driver circuit 76-R passes through LED 38-R for narrow-viewing-angle subpixel 22-RN or LED 38-R for wide-viewing-angle subpixel 22-RW.

Consider an example where privacy mode row signal line 78-R provides a control signal associated with a private mode and privacy mode column signal line 78-C also provides a control signal associated with a private mode. In this instance, both transistors T₈ and T are asserted and both transistors T₁₀ and T₁₁ are deasserted and light is only emitted by subpixel 22-RN.

Consider an example where privacy mode row signal line 78-R provides a control signal associated with a private mode and privacy mode column signal line 78-C provides a control signal associated with a public mode. In this instance, transistors T₈ and T₁₁ are asserted and transistors T₉ and T₁₀ are deasserted. Light is therefore only emitted by subpixel 22-RW.

Consider an example where privacy mode row signal line 78-R provides a control signal associated with a public mode and privacy mode column signal line 78-C provides a control signal associated with a private mode. In this instance, transistors T₈ and T₁₁ are deasserted and transistors T₉ and T₁₀ are asserted. Light is therefore only emitted by subpixel 22-RW.

Consider an example where privacy mode row signal line 78-R provides a control signal associated with a public mode and privacy mode column signal line 78-C also provides a control signal associated with a public mode. In this instance, both transistors T₈ and T₉ are deasserted and both transistors T₁₀ and T₁₁ are asserted and light is only emitted by subpixel 22-RW.

The example of emission logic circuits 80-R in FIGS. 10A and 10B are merely illustrative. In general, the emission logic circuits may have any desired arrangement that enables selective control of emission from subpixels 22-RN and 22-WN.

Each driver circuit may have a corresponding emission logic circuit. Returning to FIG. 9, driver circuit 76-R may control a drive current and an associated emission logic circuit may direct the drive current to one or both of subpixels 22-RN and 22-RW. Driver circuit 76-G may control a drive current and an associated emission logic circuit may direct the drive current to one or both of subpixels 22-GN and 22-GW. Driver circuit 76-B may control a drive current and an associated emission logic circuit may direct the drive current to one or both of subpixels 22-BN and 22-BW.

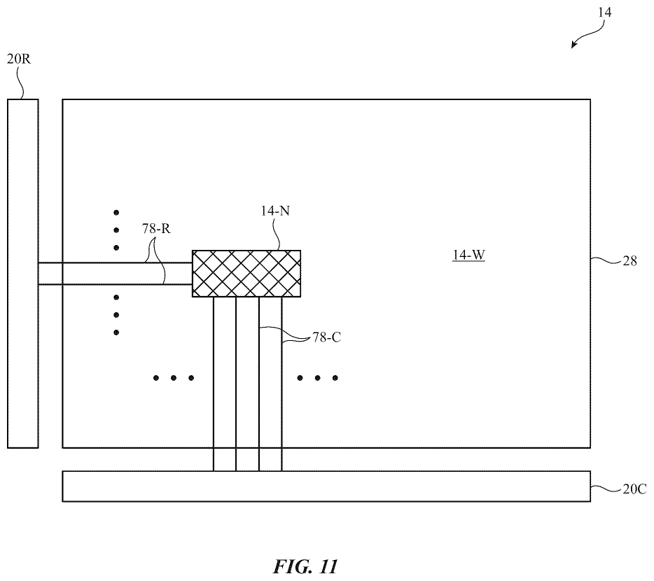

FIG. 11 is a top view of an illustrative display 14 with a public region 14-W having a wide viewing angle and a private region 14-N having a narrow viewing angle. As shown in FIG. 11, display 14 may include privacy mode row signal driver circuitry 20R that provides privacy mode row signals on privacy mode row signal lines 78-R and privacy mode column signal driver circuitry 20C that provides privacy mode column signals on privacy mode column signal lines 78-C. Privacy mode row signal driver circuitry 20R may optionally be formed as part of gate driver circuitry 20B from FIG. 2. Privacy mode column signal driver circuitry 20C may optionally be formed as part of display driver circuitry 20A from FIG. 2. Control circuitry 16 may control privacy mode row signal driver circuitry 20R and privacy mode column signal driver circuitry 20C based on the content on display 14 (e.g., the target locations of private content). Privacy mode row signal driver circuitry 20R and privacy mode column signal driver circuitry 20C may be considered part of control circuitry 16.

In FIG. 11, the privacy mode row signal lines 78-R and privacy mode column signal lines 78-C provide signals associated with a private mode to the pixels in private region 14-N. Accordingly, in private region 14-N only narrow-viewing-angle subpixels emit light. In public region 14-W, the pixels emit light using only the wide-viewing-angle subpixels (as with the emission logic circuit of FIG. 10B) or using both the wide-viewing-angle subpixels and the narrow-viewing-angle subpixels (as with the emission logic circuit of FIG. 10A). In the public region 14-W, emitting light with both private and public subpixels may increase luminance and resolution with a tradeoff of higher power consumption. Alternatively, emitting light in only the public subpixels in public region 14-W saves power consumption with a tradeoff of reduced resolution.

With the arrangement of FIGS. 9-11, any pixel in display 14 may be switched between a public mode and a private mode. This enables display 14 to have multiple discrete private regions that are aligned with selected private content. Consider the scenario in FIG. 12 where display 14 is used to present applications 82-1 and 82-2. The first application 82-1 may have an associated window. Within that window, first and second discrete regions 14-N1 and 14-N2 may be operated in a privacy mode. As an example, the first region 14-N1 may be used to display a user's username for logging into the application and the second region 14-N2 may be used to display a user's password for logging into the application. The rest of the window may be placed in public mode. The second application 82-2 (e.g., a video conferencing application) may have an associated window that is entirely private as indicated by region 14-N3. The portions 14-W of display not identified as private regions may be operated in a public mode.

FIGS. 6A and 6B show examples where microlenses are used to define narrow-viewing-angle pixels. Instead or in addition, microlenses may be used in pixels for off-axis color control. In some displays, there may be an off-axis color shift caused by change in luminance in different colors at high viewing angles. To mitigate off-axis color shifts in display 14, one or more microlenses may be formed over one or more subpixels in display 14.

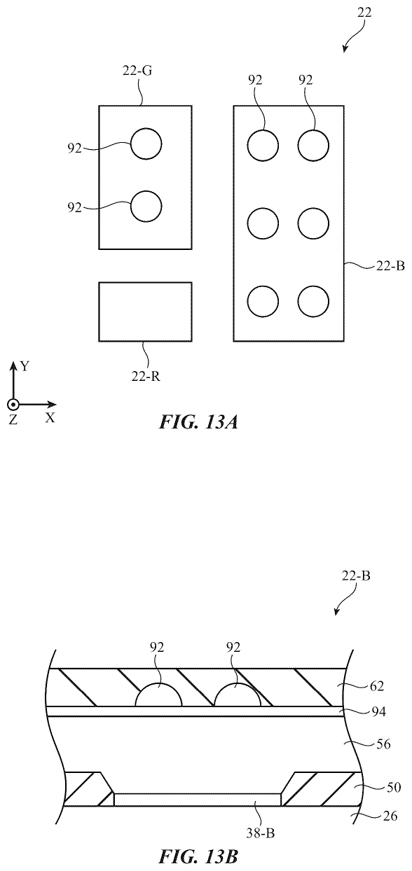

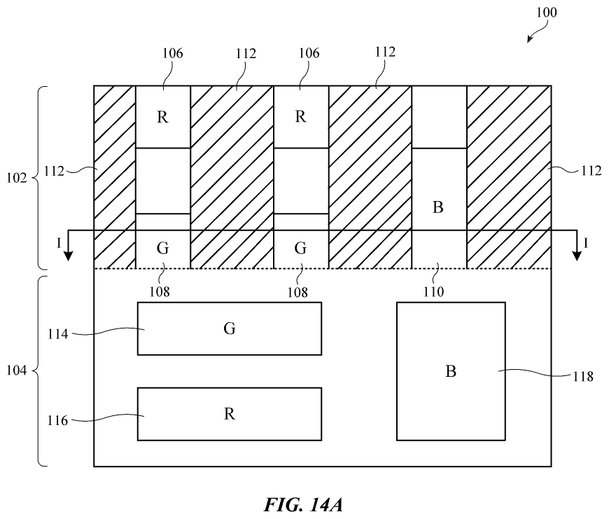

FIG. 13A is a top view of an illustrative pixel with one or more microlenses formed over one or more subpixels in the pixel. In particular, pixel 22 includes a green subpixel 22-G, a red subpixel 22-R, and a blue subpixel 22-B. In the example of FIG. 13A, green subpixel 22-G includes two overlapping microlenses 92 in an array of two rows and one column. Blue subpixel 22-B includes six overlapping microlenses 92 in an array of three rows and two columns. Red subpixel 22-R does not have any overlapping microlenses. Microlenses 92 have footprints with areas that are smaller than the total area of the light-emitting area of their subpixel. In other words, each microlens for a subpixel only partially overlaps the light-emitting area of that subpixel. With this type of arrangement, green and blue pixel light is collimated by the microlenses more than red pixel light. This increases the relative luminance of red light at high viewing angles, which may mitigate off-axis color shifts.

Including an array of microlenses for a single subpixel instead of a single microlens for a single subpixel may provide more optical power in view of thickness constraints within the system.

The array of microlenses may also be selected to control the light differently in the horizontal and vertical directions to compensate for variance in horizontal and vertical color (e.g., caused by occlusions from on-cell touch metal). In the example of FIG. 13A, there are two rows of microlenses over the green subpixel 22-G (where the rows are parallel to the X-axis) and one column of microlenses over the green subpixel 22-G (where the column is parallel to the Y-axis). In the example of FIG. 13A, there are three rows of microlenses over the blue subpixel 22-B (where the rows are parallel to the X-axis) and two columns of microlenses over the blue subpixel 22-B (where the column is parallel to the Y-axis). Therefore, in both the green and blue subpixels there are more rows of microlenses than columns of microlenses and the light is therefore collimated more along the Y-direction than along the X-direction. In general, the number of rows and columns of microlenses over a given subpixel may be tuned to optimize for color uniformity at various viewing angles and in both the horizontal and vertical directions.

FIG. 13B is a side view of the blue subpixel from FIG. 13A. As shown, the blue subpixel includes a blue light-emitting diode 38-B on substrate 26. A pixel definition layer 50 may define a light-emitting aperture for LED 38-B. One or more encapsulation layers 56 may cover and conform to LED 38-B and pixel definition layer 50. A passivation layer 94 is formed on the upper surface of encapsulation layer(s) 56. Microlenses 92 are formed on an upper surface of passivation layer 94. One or more planarization layers 62 cover and conform to microlenses 92 and passivation layer 94. Each one of encapsulation layer(s) 56 and planarization layer(s) 62 may be formed using ink jet printing (IJP) or other desired manufacturing techniques. A difference in refractive index between microlens 92 and planarization layer 62 may be greater than 0.1, greater than 0.2, greater than 0.3, greater than 0.4, greater than 0.5, etc. In one specific example, planarization layer 62 has an index of refraction of 1.5, microlens 92 has an index of refraction of 1.64, passivation layer 94 has an index of refraction of 1.9, and encapsulation layer 56 has an index of refraction of 1.5.

In FIGS. 13A and 13B, each microlens 92 has a hemispherical shape with a circular footprint. This example is merely illustrative. In general, each microlens may have a hemispherical shape with a circular footprint, a conical shape with a circular or elliptical footprint, a parabolic shape, etc. The microlens may have convex curvature (as in FIGS. 13A and 13B) and/or concave curvature.

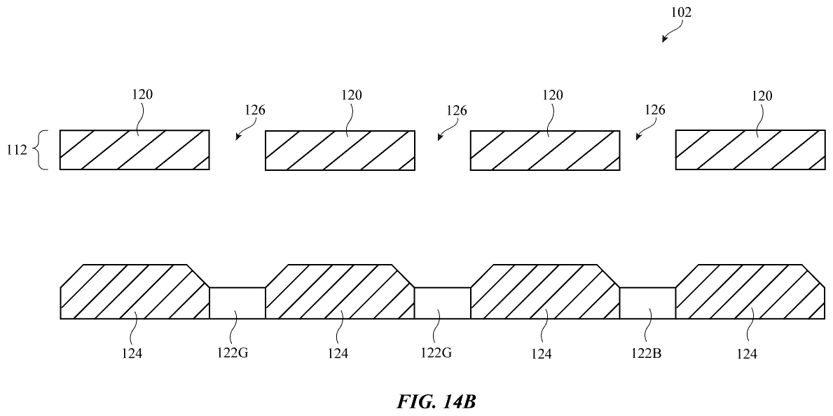

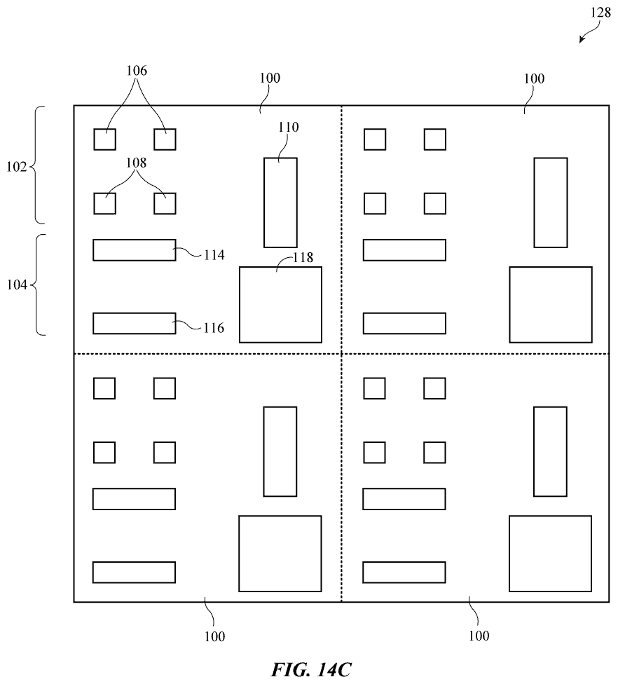

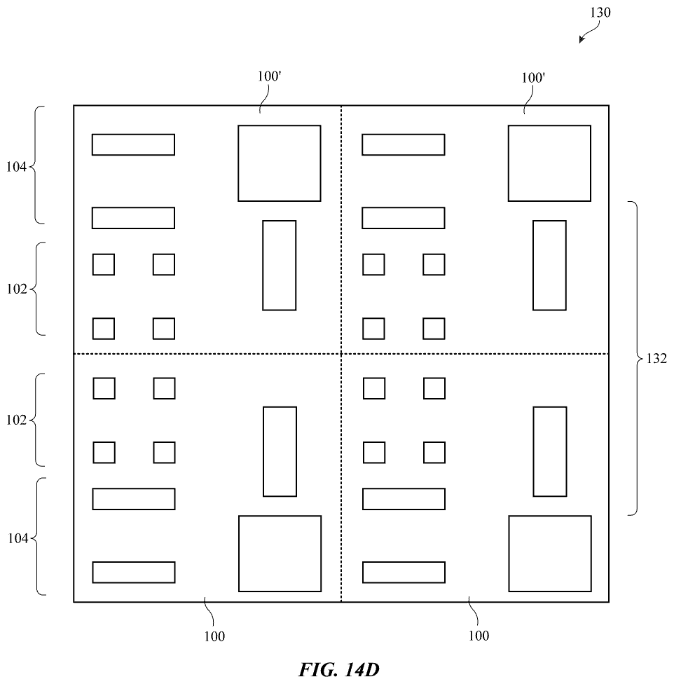

In some embodiments, a unit cell that repeats across a display may include both public pixels (or subpixels) and private pixels (or subpixels). An illustrative example of a unit cell that includes public pixels and private pixels is shown in FIG. 14A.

As shown in FIG. 14A, unit cell 100 may include private pixels 102 (each private pixel 102 including first subpixels) and public pixel 104 (each public pixel 104 including second subpixels). Private pixels 102 may include red private subpixels 106, green private subpixels 108, and blue private subpixel 110. Red private subpixels 106, green private subpixels 108, and blue private subpixel 110 may correspond with subpixels 22-R, 22-G, and 22-B, respectively of FIG. 6 and may include red, green, and blue light emitting diodes, respectively (and/or microlenses, color filter elements, encapsulation layers, diffractive optical elements, and/or passivation layers as described in connection with FIGS. 6-13). Black matrix 112 (which may correspond with black matrix 58 of FIGS. 6-8) may be formed between red private subpixels 106, green private subpixels 108, and blue private subpixel 110 to reduce the viewing angle of private pixels 102.

Public pixel 104 may include green subpixel 114, red subpixel 116, and blue subpixel 118. Public pixel 104 may not include black matrix 112, thereby allowing green subpixel 114, red subpixel 116, and blue subpixel 118 to emit light with a larger viewing angle than red private subpixels 106, green private subpixels 108, and blue private subpixel 110. However, green subpixel 114, red subpixel 115, and blue subpixel 118 may include green, red, and blue light emitting diodes, respectively (and/or microlenses, color filter elements, encapsulation layers, diffractive optical elements, and/or passivation layers as described in connection with FIGS. 6-13).

A cross-sectional side view of private pixels 102 along line I-I is shown in FIG. 14B. In particular, private pixels 102 may include light-emitting diodes 122 (two green LEDs 122G and one blue LED 122B in the illustrative example of FIG. 14B) separated by pixel definition layer 124 (which may correspond with pixel definition layer 50 of FIGS. 6-13). In operation, light-emitting diodes 122 may emit light through openings 126 in black matrix 120. In this way, the light emitted by light-emitting diodes 122 in private pixels 102 may have a narrow viewing angle.

The arrangement of the red private subpixels 106, green private subpixels 108, blue private subpixel 110, green subpixel 114, red subpixel 116 and blue subpixel 118 of FIG. 14A is merely illustrative. In general, red private subpixels 106, green private subpixels 108, blue private subpixel 110, green subpixel 114, red subpixel 116 and blue subpixel 118 may be arranged in any suitable pattern. Alternatively or additionally, unit cell 100 may include one or more red private subpixels 106, green private subpixels 108, blue private subpixels 110, green subpixels 114, red subpixels 116 and/or blue subpixels 118 in any suitable combination.

Regardless of the arrangement of unit cell 100, multiple unit cells may be arranged across a display. Illustrative examples are shown in FIGS. 14C and 14D.

As shown in FIG. 14C, display portion 128 may include four unit cells 100 in a 2×2 matrix, each including private pixels 102 and public pixel 104. In the arrangement of FIG. 14C, all four unit cells 100 may be oriented in a common direction (e.g., with private pixels 102 at the top and public pixel 104 at the bottom). However, this is merely illustrative. For example, as shown in FIG. 14D, display portion 130 may include two unit cells 100 and two unit cells 100′ in a 2×2 matrix. Each of unit cells 100 and 100′ may include private pixels 102 and public pixel 104. However, unit cells 100 may have private pixels 102 at the top and public pixels 104 at the bottom, while unit cells 100′ may have private pixels 102 at the bottom and public pixels 104 at the top. In other words, at least some of the unit cells may be oriented in different directions from one another. In this way, a larger private region 132 may be formed by adjacent private pixels 102.

Although display portions 128 and 130 of FIGS. 14C and 14D are each shown as having a 2×2 matrix of unit cells 100 (and/or 100′), this is merely illustrative. In general, a display portion may include display pixels that are arranged in a repeating pattern of any suitable number of unit cells. Moreover, a full display, such as display 14 of FIG. 2, may include any suitable number display portions, each with any suitable number of unit cells.

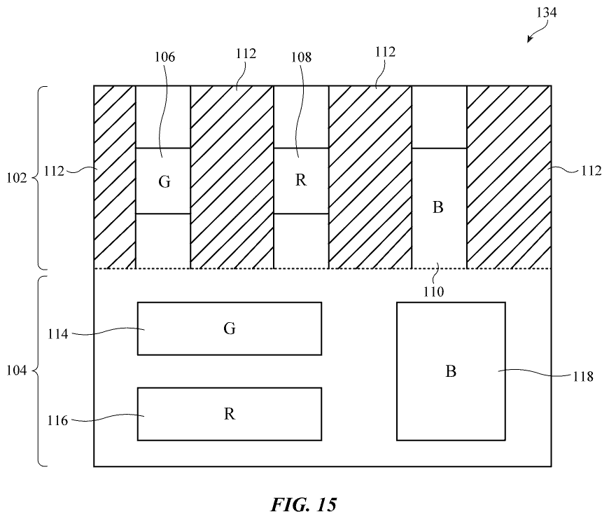

Additionally, the example of unit cell 100 of FIG. 14A is merely illustrative. In general, the subpixels in a unit cell may have any suitable layout. An example of an illustrative unit cell with an alternative layout is shown in FIG. 15.

As shown in FIG. 15, unit cell 134 may include a single green private subpixel 106, a single red private subpixel 108, and a single blue private subpixel 110 in private pixel 102. Red private subpixel 108 may be interposed laterally between green private subpixel 106 and blue private subpixel 110. Public pixel 104 may have the same layout as in unit cell 100 of FIG. 14A. Unit cell 134 may be arranged across a display, such as in 2×2 matrix of unit cells 134 oriented the same direction (e.g., as shown in FIG. 14C), or with some of the unit cells in opposite direction (e.g., as shown in FIG. 14D). However, the layout of private pixel 102 and public pixel 104 in FIG. 15 is merely illustrative. In general, private pixel 102 and/or public pixel 104 may have any suitable layout.

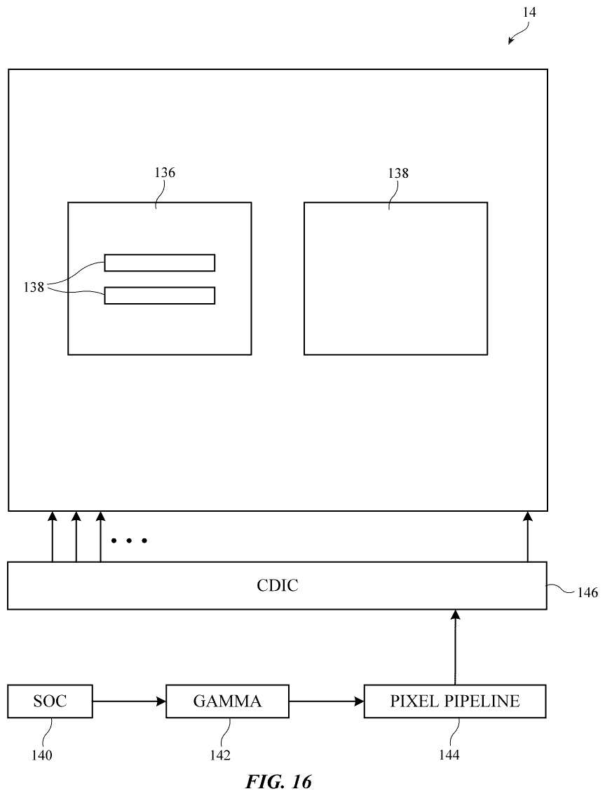

Regardless of the layout of unit cells in a display, the display may include display circuitry that allows for the display of public and private content. An illustrative example is shown in FIG. 16.

As shown in FIG. 16, display 14 may include public content region 136 and private content regions 138. Public content region 136 may include content generated with public pixels (e.g., public pixels 104 of FIGS. 14 and 15), and private content regions 138 may include content generated with private pixels (e.g., private pixels 102 of FIGS. 14 and 15). In some embodiments, the content in private content region 138 may have a narrow viewing angle to prevent the content from being seen from off-axis viewers. As illustrative examples, private content region 138 may include video calls, usernames, passwords, private account information, photographs, and/or any other suitable private content. In general, however, private content region 138 may include any desired content.

In the example of FIG. 16, some of private content regions 138 are within public content region 136. However, this arrangement is merely illustrative. In general, public and/or private content may be displayed anywhere in display 14 at any suitable time. Display 14 may generally display all public content, all private content, or a mix of public and private content at any given time.

To display the private and public content, display 14 may include display circuitry that can modify the displayed content depending on whether it is in a private content region or a public content region. For example, display 14 may include system on chip (SOC) 140, gamma circuitry 142, pixel pipeline 144, and compression/decompression data interface control (CDIC) 146.

To account for private content and public content, gamma circuitry 142 may apply a first gamma value to image data (e.g., image data from SOC 140) that is public content and a second gamma value that is different from the first gamma value to image data (e.g., image data from SOC 140) that is private content. After the different gamma values have been applied to the image data depending on whether the image data includes public and/or private content, pixel pipeline 144 may supply pixel timing controls, pixel corrections, and/or any other suitable pixel control signals to CDIC 146 depending on the content being provided by gamma circuitry 142 and SOC 140. In some embodiments, pixel pipeline 144 may generate signals based on whether displayed content is public content or private content. CDIC 146 may then drive display 14 based on the signals from pixel pipeline 144, gamma circuitry 142, and SOC 140. In this way, private content (e.g., content in private content regions 138) and/or public content (e.g., content in public region 136) may be displayed on display 14.

The foregoing is merely illustrative and various modifications can be made by those skilled in the art without departing from the scope and spirit of the described embodiments. The foregoing embodiments may be implemented individually or in any combination.

What is claimed is:

1. A display comprising:
a substrate; and
a plurality of display pixels on the substrate, wherein each display pixel in the plurality of display pixels comprises:
first subpixels;
second subpixels having a greater viewing angle than the first subpixels; and
driver circuits, wherein each driver circuit of the driver circuit drives at least one of the first subpixels and at least one of the second subpixels.

2. The display defined in claim 1, wherein the first subpixels comprise a first red subpixel, a first green subpixel, and a first blue subpixel and wherein the second subpixels comprise a second red subpixel, a second green subpixel, and a second blue subpixel.

3. The display defined in claim 2, wherein the driver circuits comprise a first driver circuit that drives the first and second red subpixels, a second driver circuit that drives the first and second green subpixels, and a third driver circuit that drives the first and second blue subpixels.

4. The display defined in claim 3, wherein each display pixel in the plurality of display pixels comprises:
emission logic circuits that each selectively connect at least one of the first subpixels and at least one of the second subpixels to a respective driver circuit.

5. The display defined in claim 3, wherein each display pixel in the plurality of display pixels comprises:
a first emission logic circuit that selectively connects the first and second red subpixels to the first driver circuit;
a second emission logic circuit that selectively connects the first and second green subpixels to the second driver circuit; and
a third emission logic circuit that selectively connects the first and second blue subpixels to the third driver circuit.

6. The display defined in claim 5, wherein the first emission logic circuit is operable in a first mode in which the first red subpixel emits light and the second red subpixel does not emit light and a second mode in which the second red subpixel emits light and the first red subpixel does not emit light.

7. The display defined in claim 5, wherein the first emission logic circuit is operable in a first mode in which the first red subpixel emits light and the second red subpixel does not emit light and a second mode in which both the first and second red subpixels emit light.

8. The display defined in claim 5, wherein the first emission logic circuit comprises two transistors that are connected between the driver circuit and a light-emitting diode for the second red subpixel.

9. The display defined in claim 8, wherein a first transistor of the two transistors has a first gate connected to a privacy mode row control signal and wherein a second transistor of the two transistors has a second gate connected to a privacy mode column control signal.

10. The display defined in claim 1, wherein each one of the first subpixels comprises a light-emitting diode and a microlens that overlaps the light-emitting diode.

11. The display defined in claim 10, wherein each one of the first subpixels comprises a color filter element that is interposed between the light-emitting diode and the microlens.

12. The display defined in claim 10, wherein each one of the first subpixels comprises a color filter element and wherein the microlens is interposed between the light-emitting diode and the color filter element.

13. The display defined in claim 1, wherein the display further comprises:
a diffractive optical element layer, wherein each one of the first subpixels is overlapped by a diffractive optical element portion of the diffractive optical element layer.

14. The display defined in claim 1, wherein the first subpixels include red private subpixels, green private subpixels, and blue private subpixels, wherein the second subpixels include red, green, and blue subpixels arranged in public pixels, wherein the plurality of display pixels is arranged in repeating unit cells, and wherein each of the unit cells includes at least some of the first subpixels and at least some of the second subpixels.

15. The display defined in claim 14, wherein each of the unit cells includes two red private subpixels, two green private subpixels, and one blue private subpixel.

16. The display defined in claim 15, wherein the first subpixels are overlapped by a black matrix layer that limits a viewing angle of the first subpixels relative to the greater viewing angle of the second subpixels.

17. The display defined in claim 14, wherein each of the unit cells includes a red private subpixel, a green private subpixel, and a blue private subpixel.

18. The display defined in claim 14, wherein all the unit cells are oriented in a common direction.

19. The display defined in claim 14, wherein at least some of the unit cells are oriented in different directions from one another.

20. The display defined in claim 14, wherein the display is configured to display private content in private content regions using the private subpixels, the display is configured to display public content in public content regions using the public pixels, and the display further comprises:
gamma circuitry that is configured to apply a first gamma value to the public content and to apply a second gamma value that is different from the first gamma value to the private content.

21. A display comprising:
a substrate; and
a plurality of display pixels on the substrate, wherein each display pixel in the plurality of display pixels comprises:
a red subpixel that is not overlapped by any microlenses;
a green subpixel that is overlapped by two or more microlenses; and
a blue subpixel that is overlapped by two or more microlenses.

22. The display defined in claim 21, wherein the blue subpixel is overlapped by more microlenses than the green subpixel.

23. The display defined in claim 21, wherein the two or more microlenses overlapping the green subpixel comprises an array of microlenses with more rows than columns.

24. The display defined in claim 21, wherein the two or more microlenses overlapping the green subpixel comprises an array of microlenses with a different number of rows than columns.

25. The display defined in claim 21, wherein the two or more microlenses overlapping the blue subpixel comprises an array of microlenses with more rows than columns.

26. The display defined in claim 21, wherein the two or more microlenses overlapping the blue subpixel comprises an array of microlenses with a different number of rows than columns.

27. A display comprising:
a substrate;
a plurality of display pixels on the substrate; and
an adjustable diffractive optical element layer that comprises a diffractive optical element layer interposed between first and second electrode layers, wherein each display pixel in the plurality of display pixels is operable in:
a first mode, wherein the adjustable diffractive optical element layer focuses light from the display pixel in the first mode and wherein the display pixel has a first viewing angle in the first mode; and
a second mode, wherein the adjustable diffractive optical element layer does not focus light from the display pixel in the second mode and wherein the display pixel has a second viewing angle that is greater than the first viewing angle in the second mode.
